(19) United States
(12) Patent Application Publication
(10) Pub. No.: US 2007/0202872 A1
(43) Pub. Date: Aug. 30, 2007

(54) Gateway apparatus and resource allocating method

(76) Inventor: Fumio Shibasaki, Sagamihara-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/710,354

(22) Filed: Feb. 23, 2007

(30) Foreign Application Priority Data
Feb. 24, 2006 (JP) 2006-048818

(51) Int. Cl. H04Q 7/20

(52) U.S. Cl. 455/428

(57) ABSTRACT

According to one embodiment, a gateway apparatus includes a pool which retains the plurality of media gateway channel resources in each of a plurality of resource groups constituted by dividing the plurality of media gateway channel resources in accordance with necessity levels thereof, a memory which stores a group table indicating the correspondence/relation between the plurality of resource groups and the communication terminals belonging to these resource groups, and a controller which refers to the group table when an arbitrary communication terminal among the plurality of communication terminals requests to use the media gateway channel resource and which reads from the pool an idle media gateway channel resource in the corresponding resource group for the arbitrary communication terminal based on the result of the reference to allocate the idle media gateway channel resource to the arbitrary communication terminal.

### CROSS-REFERENCE TO RELATED APPLICATIONS

This application is based upon and claims the benefit of priority from Japanese Patent Application No. 2006-048818, filed Feb. 24, 2006, the entire contents of which are incorporated herein by reference.

### BACKGROUND

1. Field

One embodiment of the invention relates to a system for performing voice communication between communication terminals via an IP network, such as an Internet Protocol (IP) telephone system, and to a gateway apparatus and a resource allocating method which enable voice communication between these communication terminals and a non-IP network via media gateway channel resources.

2. Description of the Related Art

Recently, a network telephone system (IP telephone system) has started to prevail in which images and sound are interactively transmitted and received as packet data via an IP network in real time.

In this IP telephone system, an IP telephone terminal is connected to the IP network, and the IP network is connected to an analog telephone line or a circuit switching network such as a public network via a gateway or a main device, and then protocol conversion, data format conversion, etc. are carried out by a media gateway channel resource in the gateway, thereby enabling voice communication between the IP telephone terminal and the circuit switching network.

Meanwhile, in a system of this kind, for example, when a plurality of IP telephone terminals request to use the media gateway channel resources in the same time zone in the gateway, the media gateway channel resources are allocated to the plurality of IP telephone terminals on the same conditions. Therefore, it is not possible to provide a service finely tuned to each of the IP telephone terminals.

It is to be noted that a technique has heretofore been proposed wherein when the ISDN line is shared for use in local area network (LAN) data communication and for use in voice communication, the number of channels allocated to the LAN data communication and the number of channels allocated to the voice communication are changed in accordance with how the channels of the ISDN line are used (e.g., Jpn. Pat. Appln. KOKAI Publication No. 11-187435).

However, this technique changes the allocation of the channels in accordance with the kinds of signals transmitted in the ISDN line, and is not directed to the IP telephone terminals.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the configuration of an IP terminal gateway system according to a first embodiment of this invention;

FIG. 2 is a diagram showing one example of storage contents of a storage unit for interface attributes corresponding to numbers shown in FIG. 1;

FIG. 3 is a diagram showing one example of storage contents of a table for channel resource necessity levels shown in FIG. 1;

FIG. 4 is a diagram showing one example of storage contents of a table for share group numbers corresponding to channel resource necessity levels shown in FIG. 1;

FIG. 5 is a diagram showing one example of storage contents of a table for a channel resource share group to be acquired shown in FIG. 1;

FIG. 6 is a diagram showing one example of storage contents of a storage unit for managing the number of resources shown in FIG. 1;

FIG. 7 is a flowchart showing a control processing procedure of a call control unit when the MG channel resource is acquired in the first embodiment;

FIG. 8 is a flowchart showing a control processing procedure of the call control unit when the MG channel resource is returned in the first embodiment;

FIG. 9 is a block diagram showing the configuration of an IP terminal gateway system according to a second embodiment of this invention;

FIG. 10 is a diagram showing one example of storage contents of a storage unit for managing the number of resources shown in FIG. 9;

FIG. 11 is a flowchart showing a control processing procedure of a call control unit when an MG channel resource is returned in the second embodiment;

FIG. 12 is a block diagram showing the configuration of an IP terminal gateway system according to a third embodiment of this invention; and

FIG. 13 is a diagram showing one example of storage contents of a table used by a call control unit in the third embodiment.

### DETAILED DESCRIPTION

Various embodiments according to the invention will be described hereinafter with reference to the accompanying drawings. In general, according to one embodiment of the invention, a gateway apparatus which accommodates a plurality of communication terminals via a packet communication network and which permits the connection of a communication network different from the packet communication network, and which connects the plurality of communication terminals and the communication network via a plurality of media gateway channel resources to permit a communication, the gateway apparatus comprising: a pool which retains the plurality of media gateway channel resources in each of a plurality of resource groups constituted by dividing the plurality of media gateway channel resources in accordance with necessity levels thereof; a memory which stores a group table indicating the correspondence/relation between the plurality of resource groups and the communication terminals belonging to these resource groups; and a controller which refers to the group table when an arbitrary communication terminal among the plurality of communication terminals requests to use the media gateway channel resource and which reads from the pool an idle media gateway channel resource in the corresponding resource group for the arbitrary communication terminal based on the result of the reference to allocate the idle media gateway channel resource to the arbitrary communication terminal.

### First Embodiment

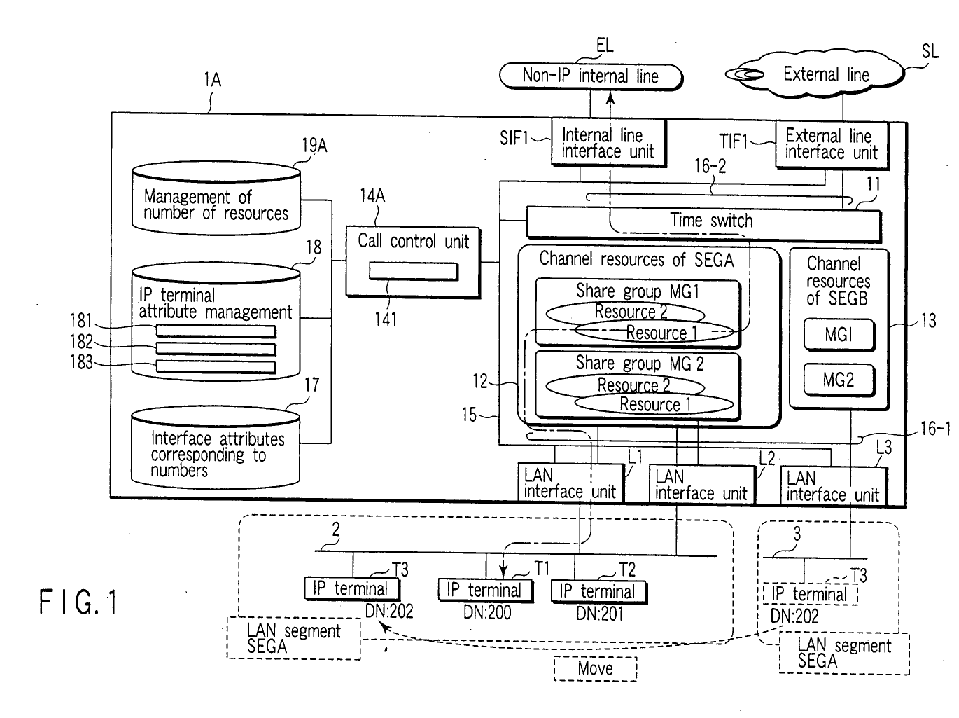

FIG. 1 is a block diagram showing the configuration of an IP terminal gateway system according to a first embodiment of this invention, wherein a sign 1A indicates a gateway apparatus.

The gateway apparatus 1A comprises an external line interface unit TIF1, an internal line interface unit SIF1, LAN interface units L1 to L3, a time switch 11, shared resource retention units 12 and 13 (hereinafter referred to as retention units 12 and 13) including pools, and a call control unit 14A. Among these units, the external line interface unit TIF1, the internal line interface unit SIF1, the LAN interface units L1 to L3, the time switch 11 and the call control unit 14A are mutually connected via a control bus 15. Moreover, the external line interface unit TIF1, the internal line interface unit SIF1, the LAN interface units L1 to L3, the time switch 11, and the shared resource retention units 12 and 13 are mutually connected via voice buses 16-1 and 16-2.

Furthermore, to the call control unit 14A, there are connected a storage unit 17 for interface attributes corresponding to numbers, a storage unit 18 for managing IP terminal attributes, and a storage unit 19A for managing the number of resources.

The external line interface unit TIF1 is connected to an external line SL of, for example, a public network, and performs an interface operation such as the establishment of a call with the external line SL. Moreover, the external line interface unit TIF1 sends/receives, to/from the call control unit 14A via the control bus 15, various kinds of control information concerning the operation of interfacing with the external line SL.

The internal line interface unit SIF1 accommodates a non-IP internal line EL, and a plurality of telephone terminals (not shown) such as analog telephones and digital key telephones are connected to the non-IP internal line EL. The internal line interface unit SIF1 performs an interface operation such as transmission/receipt of signals to/from the telephone terminals and transfer of digital signals. Moreover, the internal line interface unit SIF1 sends/receives, to/from the call control unit 14A via the control bus 15, various kinds of control information concerning the operation of interfacing with the non-IP internal line EL.

The LAN interface units L1 and L2 accommodate a LAN 2 belonging to a segment A (SEGA), and IP terminals T1 and T2 as telephone terminals are connected to the LAN 2. The LAN interface units L1 and L2 perform an interface operation such as transmission/reception to/in the IP terminals T1 and T2. Moreover, the LAN interface units L1 and L2 send/receive, to/from the call control unit 14A via the control bus 15, various kinds of control information concerning the operation of interfacing with the LAN 2. It is to be noted that an internal line telephone number (DN: 200) is allocated to the IP terminal T1 and an internal line telephone number (DN: 201) is allocated to the IP terminal T2.

The LAN interface unit L3 accommodates a LAN 3 belonging to a segment B (SEGB), and an IP terminal T3 as a telephone terminal is connected to the LAN 3. The LAN interface unit L3 performs an interface, operation such as transmission/reception to/in the IP terminal T3. Moreover, the LAN interface unit L3 sends/receives, to/from the call control unit 14A via the control bus 15, various kinds of control information concerning the operation of interfacing with the LAN 3. It is to be noted that an internal line telephone number (DN: 202) is allocated to the IP terminal T3.

In accordance with an instruction of the call control unit 14A, the time switch 11 exchanges channels of signals which are transmitted, via the voice buses 16-1 and 16-2, between the external line interface unit TIF1 and the internal line interface unit SIF1, between the external line interface unit TIF1 and the LAN interface units L1 to L3, and between the internal line interface unit SIF1 and the LAN interface units L1 to L3.

A plurality of media gateway (MG) channel resources belonging to the segment A are retained in the retention unit 12. The MG channel resources are used to carry out protocol conversion, data format conversion, etc. between the IP terminals T1 to T3 and the external line SL or the non-IP internal line EL. Moreover, these MG channel resources are divided into share groups MG1 and MG2 in accordance with necessity levels (two necessity levels here).

A plurality of MG channel resources belonging to the segment B are retained in the retention unit 13. Moreover, these MG channel resources are divided into share groups MG1 and MG2 in accordance with necessity levels (two necessity levels here).

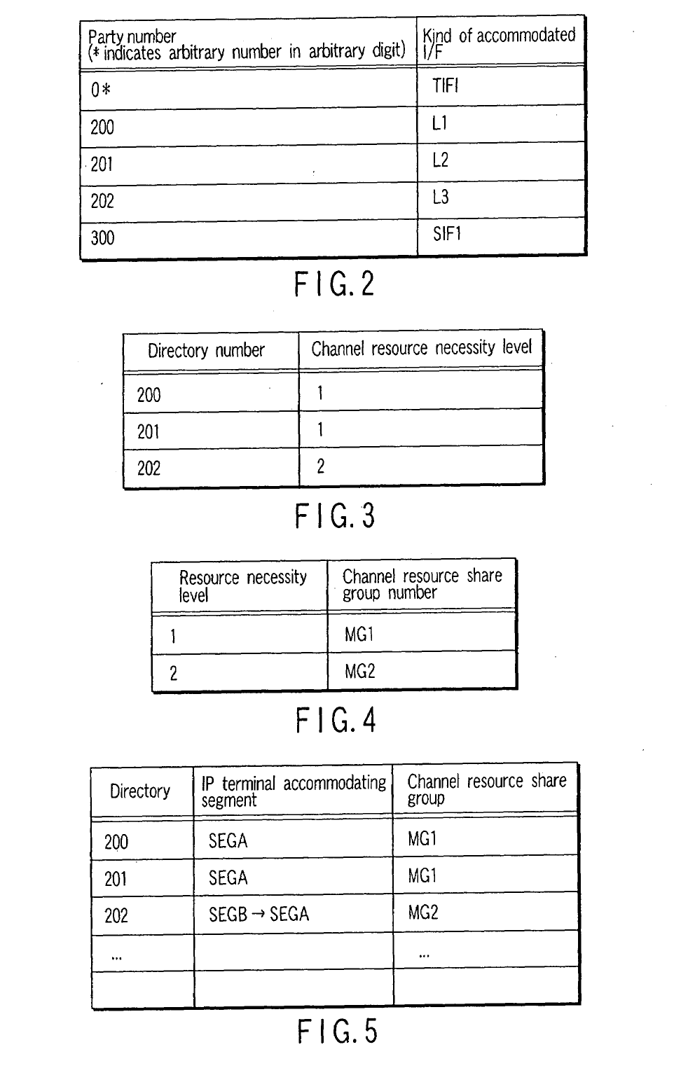

As shown in FIG. 2, the storage unit 17 stores data indicating the correspondence/relation between telephone numbers (DN), and the external line interface unit TIF1, the internal line interface unit SIF1 and the LAN interface units L1 to L3.

The storage unit 18 is provided with a table 181 for MG channel resource necessity levels (hereinafter referred to as a table 181), a table 182 for share group numbers corresponding to the MG channel resource necessity levels (hereinafter referred to as a table 182), and a table 183 for the channel resource share group to be acquired (hereinafter referred to as a table 183).

As shown in FIG. 3, the table 181 stores data indicating the correspondence/relation between the telephone numbers of the IP terminals T1 to T3 and the MG channel resource necessity levels.

As shown in FIG. 4, the table 182 stores data indicating the correspondence/relation between the resource necessity levels and the MG channel resource share group numbers.

As shown in FIG. 5, the table 183 stores data indicating the correspondence/relation among the telephone numbers of the IP terminals T1 to T3, the segments A and B of the LANs 2 and 3, and the MG channel resource share groups. In this table 183, the same channel resource share group MG2 is allocated to the IP terminal T3 in both the segments A and B.

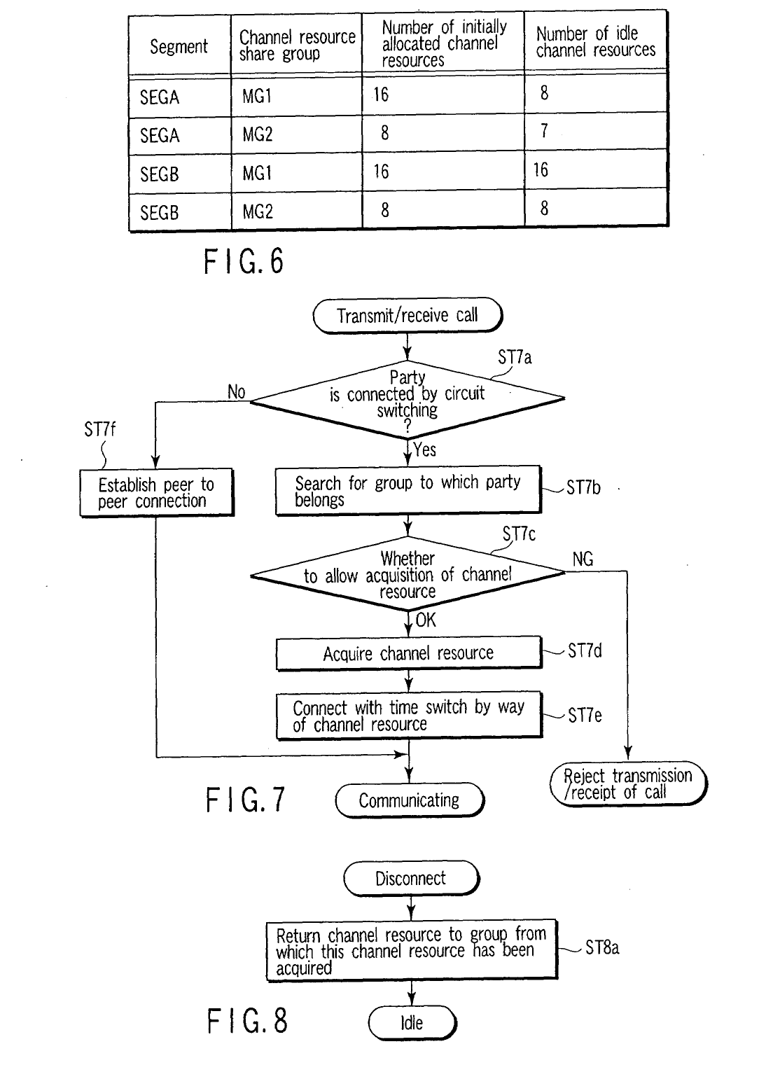

As shown in FIG. 6, the storage unit 19A stores data indicating the correspondence/relation among the segments, the MG channel resource share groups, the number of initially allocated channel resources, and the number of idle channel resources. Among the above, the number of idle channel resources can be rewritten by the call control unit 14A in accordance with how the MG channel resources are used.

On the other hand, the call control unit 14A comprises a channel resource allocation control unit 141 (hereinafter referred to as a control unit 141) in addition to a control function of achieving operation as the gateway apparatus 1A. When connecting the IP terminal T1 and the external line SL or the non-IP internal line EL, the control unit 141 refers to the storage contents of the storage unit 17, the storage unit 18 and the storage unit 19A, and acquires an idle MG channel resource from the retention unit 12 based on the result of this reference and controls the time switch 11, thereby connecting the IP terminal T1 and the external line SL or the non-IP internal line EL.

Next, the operation of the IP terminal gateway system having a configuration as above will be described.

FIG. 7 is a flowchart showing a control processing procedure of the call control unit 14A, when the MG channel resource is acquired.

Here, a case will be supposed where a call is made from the IP terminal T1 to the non-IP internal line EL.

When a call is made from the IP terminal T1, the call control unit 14A refers to a party telephone number contained in the call and to the storage unit 17 to judge whether the party to which the IP terminal T1 is to be connected to is a terminal requiring an MG channel resource (block ST7a). Then, when the party is the internal line interface unit SIF1 or the external line interface unit TIF1, the MG channel resource is required, thus proceeding to next acquisition processing.

Each of the IP terminals T1 to T3 has a level of necessity for the MG channel resource, and the resource share groups corresponding to the necessity levels are defined. These are combined to define the numbers of the share groups from which the IP terminals T1 to T3 can acquire the MG channel resources.

The call control unit 14A searches, from the table 183, for the share group number MG1 of the segment A (SEGA) to which the IP terminal T1 belongs (block ST7b), and judges how many idle MG channel resources are in the group MG1 with reference to the storage unit 19A (block ST7c). Here, there are eight idle MG channel resources, so that the acquisition is possible (OK). Thus, the call control unit 14A acquires one MG channel resource (resource 1 in FIG. 1) from the share group MG1 of the retention unit 12 (block ST7d), and connects with the time switch 11 by way of this MG channel resource (block ST7e). As a result, a communication link is established between the IP terminal T1 and the non-IP internal line EL so that they are in communication.

It is to be noted that when there is no acquirable MG channel resource in block ST7c (NG), the call control unit 14A rejects the transmission of the signal from the IP terminal T1 to the non-IP internal line EL.

Furthermore, when the party is the IP terminal T2 in block ST7a (NO), the call control unit 14A establishes a communication link between the IP terminal T1 and the IP terminal T2 by peer-to-peer connection (block ST7f).

FIG. 8 is a flowchart showing a control processing procedure of the call control unit 14A when the MG channel resource is returned.

When the communication is finished, the call control unit 14A returns the MG channel resource allocated to the IP terminal T1 to the share group MG1 in the retention unit 12 from which this MG channel resource has been acquired (block ST8a).

As described above, according to the first embodiment, in the gateway apparatus 1A, the plurality of MG channel resources retained in the retention units 12 and 13 are grouped into the share groups MG1 and MG2 in accordance with the necessity levels, and the storage unit 18 and the storage unit 19A are provided in which the share groups MG1 and MG2 are matched with the IP terminals T1 to T3, so that the call control unit 14A refers to the storage unit 18 and the storage unit 19A when a communication is performed, for example, between the IP terminal T1 and the non-IP internal line EL or the external line SL, thereby identifying the MG channel resource to be acquired from the retention units 12 and 13.

Therefore, when one system is shared between, for example, a department which most frequently uses the non-IP internal line EL or the external line SL and a department which uses the non-IP internal line EL or the external line SL a small number of times, the number of MG channel resources to be used can be restricted for each of the departments. Thus, it is possible to efficiently allocate the MG channel resources and provide a service finely tuned to each of the users of the IP terminals T1 to T3 when a small number of MG channel resources are shared by the IP terminals T1 to T3 larger in number than these MG channel resources without adding any MG channel resource.

Furthermore, in the first embodiment, the share groups MG1 and MG2 are matched with the IP terminals T1 to T3 for each of the segments A and B of the LANs 2 and 3 in the storage unit 18 and the storage unit 19A, so that the MG channel resources can be allocated to the IP terminals T1 to T3 in units of the segments A and B.

Moreover, in the first embodiment, the table 183 stores data so that the IP terminal T3 is allocated to the share group MG2 in which the necessity level is the same in both the segments A and B, so that even if the IP terminal T3 moves from the segment B to the segment A, the IP terminal T3 belongs to the share group in the segment A in which its necessity level is the same as in the share group in the segment B, such that the IP terminal T3 can continuously use the same service as that in the segment B.

### Second Embodiment

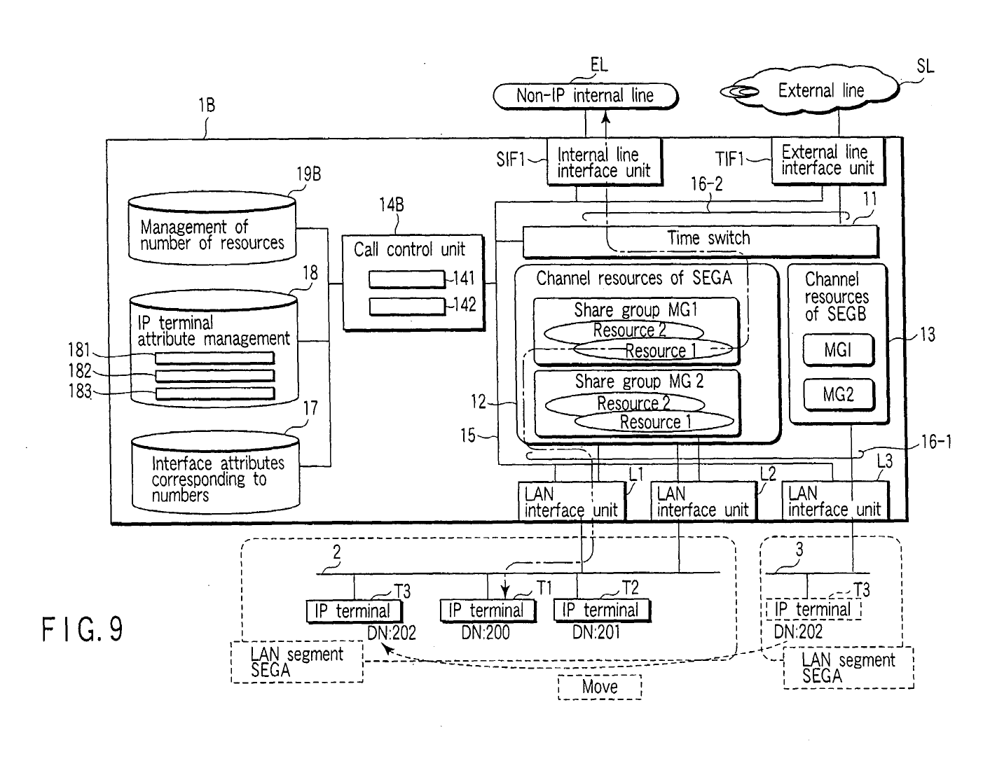

FIG. 9 is a block diagram showing the configuration of an IP terminal gateway system according to a second embodiment of this invention. It is to be noted that the same sings are given in FIG. 9 to the same parts as those in FIG. 1 and these parts are not described in detail.

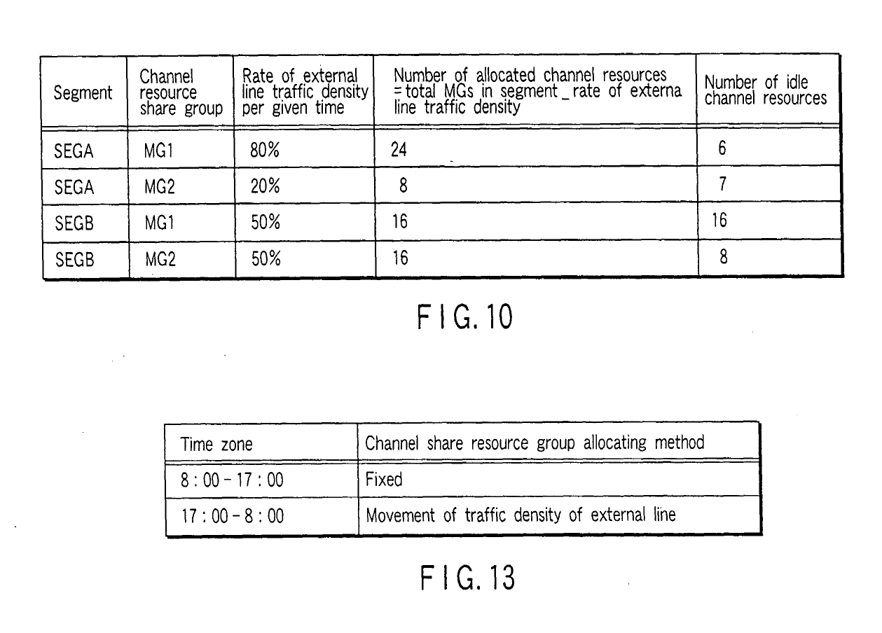

In FIG. 9, a call control unit 14B comprises a control unit 142 for changing the number of resources. Further, as shown in FIG. 10, a storage unit 19B stores data indicating the correspondence/relation among segments A and B, share groups MG1 and MG2, the rate of external line traffic density per given time, the number of allocated MG channel resources and the number of idle MG channel resources.

The control unit 142 monitors how much an external line SL is used at regular time intervals (the rate of external line traffic density per given time), and changes the number of MG channel resources allocated to the share groups MG1 and MG2 in each of the segments A and B in the storage unit 19B based on the result of the monitoring.

Next, the operation of the IP terminal gateway system having a configuration as above will be described.

FIG. 11 is a flowchart showing a control processing procedure of the call control unit 14B when the MG channel resource is returned.

When a communication is finished, the call control unit 14B judges whether the MG channel resource can be returned to the group from which this MG channel resource has been acquired (block ST11a). If the number of MG channel resources allocated at this point is not exceeded as a result of returning the MG channel resource (OK), the call control unit 14B returns the acquired MG channel resource to the share group from which this MG channel resource has been acquired (block ST11b).

On the other hand, if the number is exceeded (NO), the call control unit 14B returns the acquired MG channel resource to a group other than the group from which this MG channel resource has been acquired (block ST11c). Here, there are only two groups in the same segment, so that the group other than the group from which the MG channel resource has been acquired is uniquely determined. However, when there are more than two groups, the number of idle MG channel resources are divided by the number of allocations in regard to the share groups other than the group from which the MG channel resource has been acquired to calculate a residual ratio, and the MG channel resource is returned to the share group having the lowest residual ratio.

As described above, according to the second embodiment, the call control unit 14B variably sets the number of MG channel resources of the share groups MG1 and MG2 in each of the segments A and B to an optimum number of channel resources, for example, in accordance with the density of traffic to the external line SL, so that it is possible to relatively flexibly allocate the MG channel resources to the IP terminal T3 belonging to the share groups MG1 and MG2.

### Third Embodiment

In a third embodiment of this invention, whether to fix or vary the number of MG channel resources allocated to share groups MG1 and MG2 is automatically set in accordance with time zones.

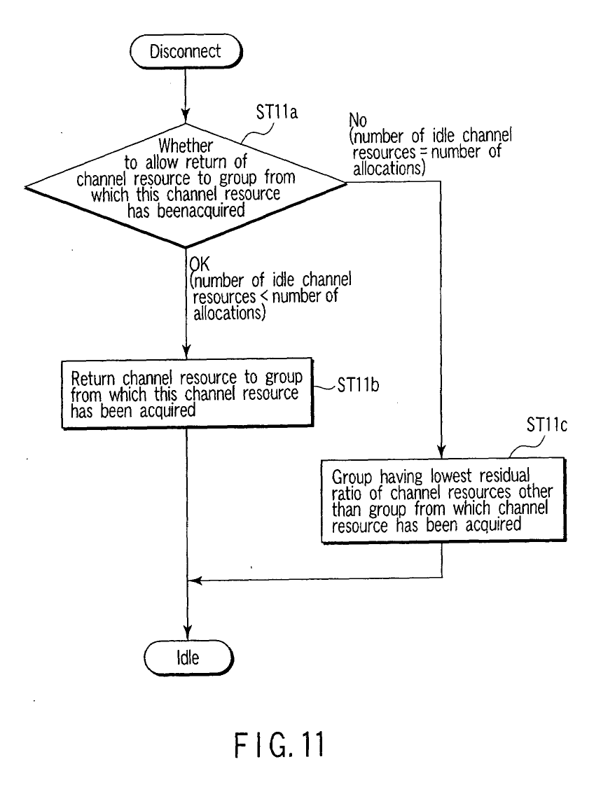

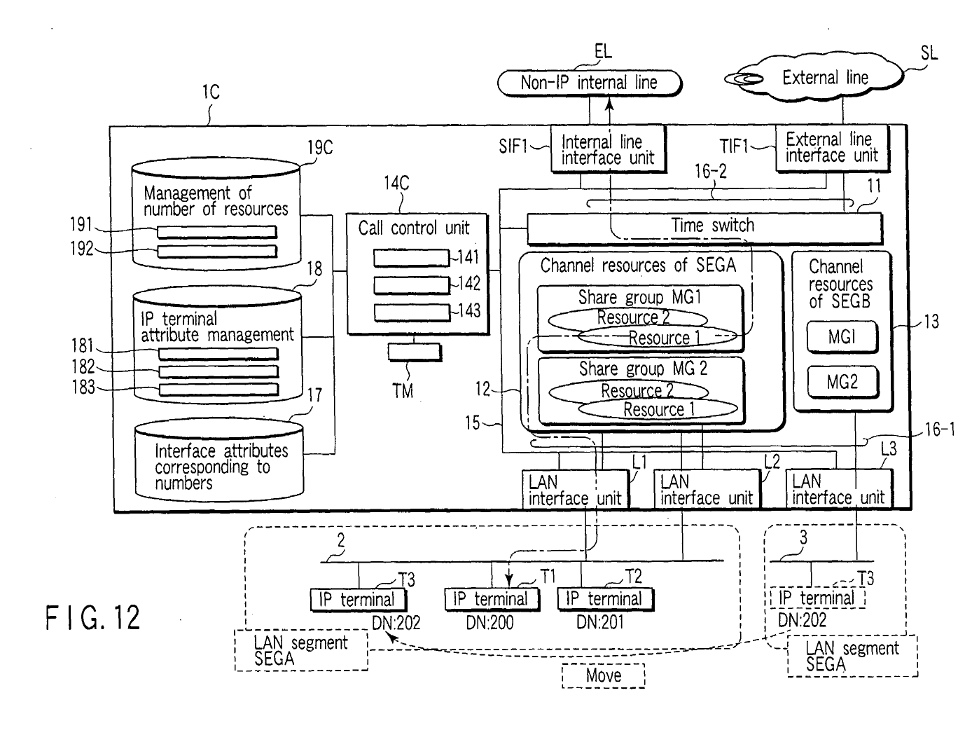

FIG. 12 is a block diagram showing the configuration of an IP terminal gateway system according to a third embodiment of this invention. It is to be noted that the same sings are given in FIG. 12 to the same parts as those in FIG. 1 and these parts are not described in detail.

In FIG. 12, a call control unit 14C comprises a channel allocating method changing control unit 143 (hereinafter referred to as a control unit 143). Further, a storage unit 19C is provided with a storage unit 191 for a fixed number of resources, and a storage unit 192 for a varied number of resources. The storage unit 191 stores storage contents shown in FIG. 6. The storage unit 192 stores storage contents shown in FIG. 10.

As shown in FIG. 13, the control unit 143 switches from the storage unit 192 to the storage unit 191 when time clocked by a timer TM becomes 8:00, and switches from the storage unit 191 to the storage unit 192 when the time becomes 17:00.

Thus, in the third embodiment, a fixed allocation is provided during normal working hours (8:00 to 17:00) because it is considered that there is not much change in the traffic of communications and the prioritized allocation of the MG channel resources suitable for work contents is needed. During other times (17:00 to 8:00), the allocating method can be automatically changed; for example, the MG channel resources are allocated in conjunction with the rate of the traffic density of an external line so as to minimize the possibility that the resources are blocked due to a call with an external line SL. It is to be noted that, for example, communication traffic can be used as a switching condition instead of the time zones.

### Other Embodiments

This invention is not limited to the embodiments described above. For example, the case has been described in the above embodiments where a plurality of MG channel resources are divided into two groups, but the MG channel resources may be divided into a larger number of groups.

Furthermore, the case of two segments has been described in the above embodiments, but this invention can also be carried out when there are a larger number of segments.

In addition, various modifications can be made without departing from the spirit of this invention in the kind and configuration of the system, the configuration of the gateway apparatus, the kind of IP terminal such as a telephone terminal, the storage contents of the storage units, the control procedure of acquiring the MG channel resource and the control procedure of returning the MG channel resource, etc.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A gateway apparatus which accommodates a plurality of communication terminals via a packet communication network and which permits the connection of a communication network different from the packet communication network, and which connect the plurality of communication terminals and the communication network via a plurality of media gateway channel resources to permit a communication, the gateway apparatus comprising:
a pool which retains the plurality of media gateway channel resources in each of a plurality of resource groups constituted by dividing the plurality of media gateway channel resources in accordance with necessity levels thereof;
a memory which stores a group table indicating the relationship between the plurality of resource groups and the communication terminals belonging to these resource groups; and
a controller which refers to the group table when an arbitrary communication terminal among the plurality of communication terminals requests to use the media gateway channel resource and which reads from the pool an idle media gateway channel resource in the corresponding resource group for the arbitrary communication terminal based on the result of the reference to allocate the idle media gateway channel resource to the arbitrary communication terminal.

2. The gateway apparatus according to claim 1, when the packet communication network is divided into a plurality of segments,
wherein the pool retains the plurality of channel resources belonging to the respective resource groups for each of the segments, and
the memory stores the group table for each of the segments.

3. The gateway apparatus according to claim 2, wherein the memory stores a plurality of group tables belongs to the resource group which the necessity level of this communication terminal is same in between a first segment and a second segment among the plurality of segments, in which at least one of the plurality of communication terminals.

4. The gateway apparatus according to claim 1, further comprising a change controller which changes the number of media gateway channel resources for each of the resource groups retained in the pool in accordance with a preset condition.

5. The gateway apparatus according to claim 4, wherein
the change controller includes:
a first mode which fixes the number of media gateway channel resources for each of the resource groups retained in the pool;
a second mode which changes the number of media gateway channel resources for each of the resource groups retained in the pool; and
a mode selecting controller which selectively executes the first and second modes in accordance with the condition.

6. The gateway apparatus according to claim 4, wherein the change controller uses, to judge the condition, one of a time zone, the frequency of use of the media gateway channel resources, and the idleness of the media gateway channel resource in the resource group from which the used media gateway channel resource has been acquired in returning the used media gateway channel resource to this resource group, or uses a combination of the time zone and the frequency of use.

7. A resource allocating method for use in a gateway apparatus which accommodates a plurality of communication terminals via a packet communication network, and which permits the connection of a communication network different from the packet communication network, and which connects the plurality of communication terminals and the communication network via a plurality of media gateway channel resources to permit a communication, the resource allocating method comprising:
retaining the plurality of media gateway channel resources in each of a plurality of resource groups constituted by dividing the plurality of media gateway channel resources in accordance with necessity levels thereof, in a pool;
storing a group table indicating the relationship between the plurality of resource groups and the communication terminals belonging to these resource groups, in a memory;
referring to the group table when an arbitrary communication terminal among the plurality of communication terminals requests to use the media gateway channel resource, and
reading from the pool an idle media gateway channel resource in the corresponding resource group for the arbitrary communication terminal based on the result of the reference to allocate the idle media gateway channel resource to the arbitrary communication terminal.
